(19) United States
(12) Patent Application Publication
(10) Pub. No.: US 2024/0037628 A1
(43) Pub. Date: Feb. 1, 2024

(54) METHODS AND SYSTEMS FOR PROVIDING VEHICLE INFORMATION BASED ON A VEHICLE POWERTRAIN TYPE

(71) Applicant: Toyota Connected North America, Inc., Plano, TX (US)

(72) Inventors: Olarinre Salako, Little Elm, TX (US); Shravanthi Denthumdas, Frisco, TX (US); Imad Zahid, Carrollton, TX (US); Mark McClung, Celina, TX (US); Daniel Holman, Allen, TX (US); Zach Stallbohm, Richardson, TX (US); Erik Edmonds, St. Louis, MO (US); Gianna Coburn, Richardson, TX (US)

(73) Assignee: Toyota Connected North America, Inc., Plano, TX (US)

(21) Appl. No.: 17/876,676

(22) Filed: Jul. 29, 2022

(51) Int. Cl. G06Q 30/06

(52) U.S. Cl. CPC G06Q 30/0627

(57) ABSTRACT

A method for providing vehicle recommendations based on a vehicle powertrain type is provided. The method includes obtaining a geographical location related to a user, receiving data indicating availability of energy transition infrastructure in an area including the geographical location, determining a vehicle powertrain type based on the data, determining inventory information of a vehicle having the determined vehicle powertrain type, and providing information related to the vehicle based on the inventory information to the user via a user interface.

### TECHNICAL FIELD

The present specification generally relates to methods and systems for providing vehicle information based on a vehicle powertrain type.

### BACKGROUND

As part of global fight against the climate change, original equipment manufacturers (OEM) are now growing their inventory of electrified powertrains. A vehicle powertrain type is relevant to environmental friendliness. For example, the more electrified a powertrain, the more environmentally friendly is the powertrain. Therefore, our environment and users benefit from a vehicle selecting system providing information related to the vehicle powertrain type.

### SUMMARY

In one embodiment, a method includes obtaining a geographical location related to a user, receiving data indicating availability of energy transition infrastructure in an area including the geographical location, determining a vehicle powertrain type based on the data, determining inventory information of a vehicle having the determined vehicle powertrain type, and providing information related to the vehicle based on the inventory information to the user via a user interface.

In another embodiment, a system includes a user interface and a processor that performs a computer-implemented method. The method includes obtaining a geographical location related to a user, receiving data indicating availability of energy transition infrastructure in an area including to the geographical location, determining a vehicle powertrain type based on the data, determining inventory information of a vehicle having the determined vehicle powertrain type, and providing information related to the vehicle based on the inventory information to the user via the user interface.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a system for providing information based on a vehicle powertrain type, according to one or more embodiments shown and described herein;

FIG. 2A schematically depicts a flowchart of a method for providing information based on a vehicle powertrain type, according to one or more embodiments shown and described herein;

FIG. 2B schematically depicts a flowchart of a method for providing specific vehicle recommendations based on a vehicle powertrain type, availability of energy transition infrastructures, and user preferences, according to one or more embodiments shown and described herein;

FIG. 3 depicts an exemplary embodiment of displayed information, according to one or more embodiments shown and described herein;

FIG. 4 depicts another exemplary embodiment of displayed information, according to one or more embodiments shown and described herein; and

FIG. 5 depicts yet another exemplary embodiment of displayed information, according to one or more embodiments shown and described herein.

Reference will now be made in greater detail to various embodiments of the present disclosure, some embodiments of which are illustrated in the accompanying drawings.

### DETAILED DESCRIPTION

A vehicle finder system allows users to filter and select a vehicle based on their preferences. Users may wish to make a choice of a vehicle based on their needs and concerns on fuel efficiencies and environmental friendliness (i.e., green choice). Methods and systems provided here utilize an availability of energy transition infrastructure associated with users' locations, point of interests, commuting routes, or the like to narrow down vehicle options based on vehicle powertrain types. Various embodiments of the methods and systems will be described in more detail herein.

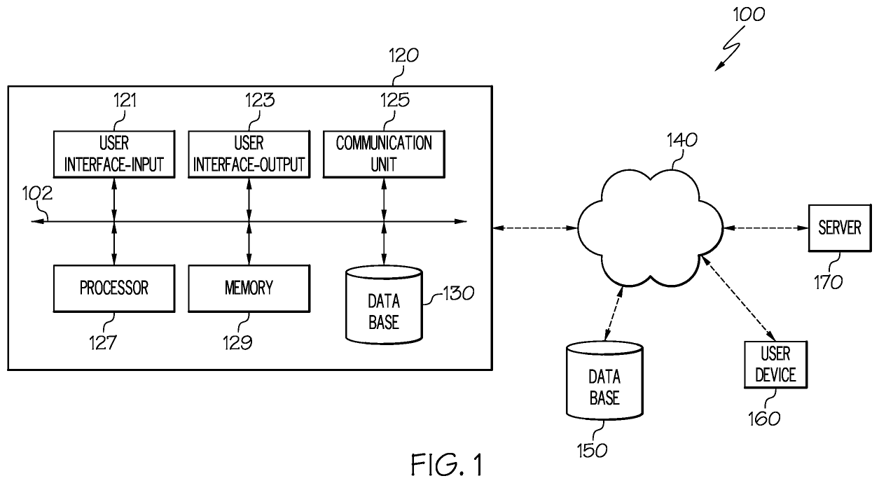

Referring to FIG. 1, a system 100 providing information based on a vehicle powertrain type to a user is shown. The system 100 may include a vehicle recommendation module 120. The vehicle recommendation module 120 may include a user interface input device 121, a user interface output device 123, a communication unit 125, a processor 127, a memory 129, and a database 130, which are communicatively coupled to a communication path 102. The communication path 102 may communicatively couple the user interface input device 121, the user interface output device 123, the communication unit 125, the processor 127, the memory 129, and the database 130. The vehicle recommendation module 120 is communicatively coupled to a network 140 (e.g., a cloud network, wireless network, etc.).

The user interface input device 121 receives input from a user. The user input device may be a keyboard, a mouse, a touch pad, a mic, a camera, or any device that may receive information input from the user. In embodiments, the user may input location information of the user. The location information may include, but not limited to, a home address, an office address, a commuting route, locations of frequently visited grocery stores, restaurants, shopping stores, and the like. The user interface input device 121 may also receive user preferences for green factors, such as fuel types, fuel efficiencies, or the like. In embodiments, the user interface input device 121 may receive user preferences associated with a vehicle, such as a size, a number of seats, a number of doors, a vehicle type (e.g., sedan, sports utility vehicle, truck, pickup truck, crossover, or the like), a maker, or the like. In embodiments, the user interface input device 121 may also receive information about presence of energy transition infrastructures. For example, a user may input information about whether a charging station is located at the user's home or at the user's workplace.

The user interface output device 123 may be a display or a speaker that may provide information to the user. For example, the user interface output device 123 may include any known or yet-to-be-developed display, such as LCD, LED, plasma, OLED, CRT, projection, holographic, electronic paper, or any other type of suitable output display. In embodiments, the user interface output device 123 may be interactive such that an interactive display being capable of providing functionalities of the user interface output device 123 and the user interface input device 121. If provided as a tactile display, the user interface output device 123 may be any device capable of providing tactile output in the form of refreshable tactile messages.

The communication unit 125 communicatively couple the vehicle recommendation module 120 to the network 140. The communication unit 125 may be any device capable of transmitting and/or receiving data with external databases (e.g., a database 150), user devices (e.g., a user device 160), or servers (e.g., a server 170) directly or via a network, such as the network 140. Accordingly, the communication unit 125 includes a communication transceiver for sending and/or receiving any wired or wireless communication. For example, the communication unit 125 may include an antenna, a modem, LAN port, Wi-Fi card, WiMax card, mobile communications hardware, near-field communication hardware, satellite communication hardware and/or any wired or wireless hardware for communicating with other networks and/or devices. In embodiments, the communication unit 125 may include hardware configured to operate in accordance with the Bluetooth wireless communication protocol and may include a Bluetooth send/receive module for sending and receiving Bluetooth communications.

The vehicle recommendation module 120 includes, for example, one or more processors (e.g., a processor 127) and one or more memories (e.g., a memory 129) storing one or more machine-readable instructions. The one or more processors may include any device capable of executing machine-readable instructions. Accordingly, the one or more processors may be a controller, an integrated circuit, a microchip, a computer, or any other computing device. The one or more processors and the one or more memory modules may be communicatively coupled to the other components of the system 100 via the network 140. In embodiments, the processor 127 and the memory 129 are a local server.

In embodiments, the system 100 includes a server 170 including one or more processors and one or more memories, which may be a remote server or an edge server.

In embodiment, the vehicle recommendation module 120 includes one or more internal databases (e.g., a database 130) to store data associated with users or vehicles. In embodiments, the data associated with users, vehicles, or energy transition infrastructures may be stored in either or both of the internal databases and the external databases (e.g., the database 130 and the database 150). The data may include information related to various factors that are associated with user needs. For example, the various factors include factors associated with energy transition infrastructures including availabilities of energy transition infrastructures, locations of energy transition infrastructures, or the like. Additionally, the various factors include factors associated with vehicles including powertrain types of vehicles, sizes of vehicles, types of vehicles, number of seats of vehicles, makers of vehicles, inventory information of vehicles, or the like. Moreover, the various factors include factors associated with users including user preference information, geographical locations of users, history of user preferences, commute routes of users, point of interests of users, or the like.

In embodiments, the database 150 may be a database of the U.S. government. For example, the database 150 may be a database of alternative fuels of the Department of Energy storing information associated with energy transition infrastructures. Energy transition infrastructures may provide transition of alternative energy, such as biodiesel, electricity, ethanol, hydrogen, natural gas, propane, or the like. In other embodiments, the database 130 may be a database of an automaker or an automobile dealership storing information associated with vehicles. In embodiments, the database 130 may be a database of information associated with users.

The user device 160 may be a computer, a smart phone, or a tablet capable of receiving, outputting, processing, or storing data. A user may provide information associated with the user via the user device 160 via the network 140. The data provided by the user may be shared among the components communicatively coupled to the network 140. The user device 160 may include a location module (e.g., a GPS module) providing a current location of the user device 160 indicative of a geographical location of the user.

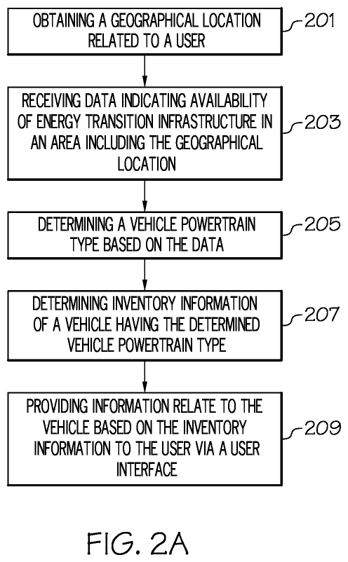

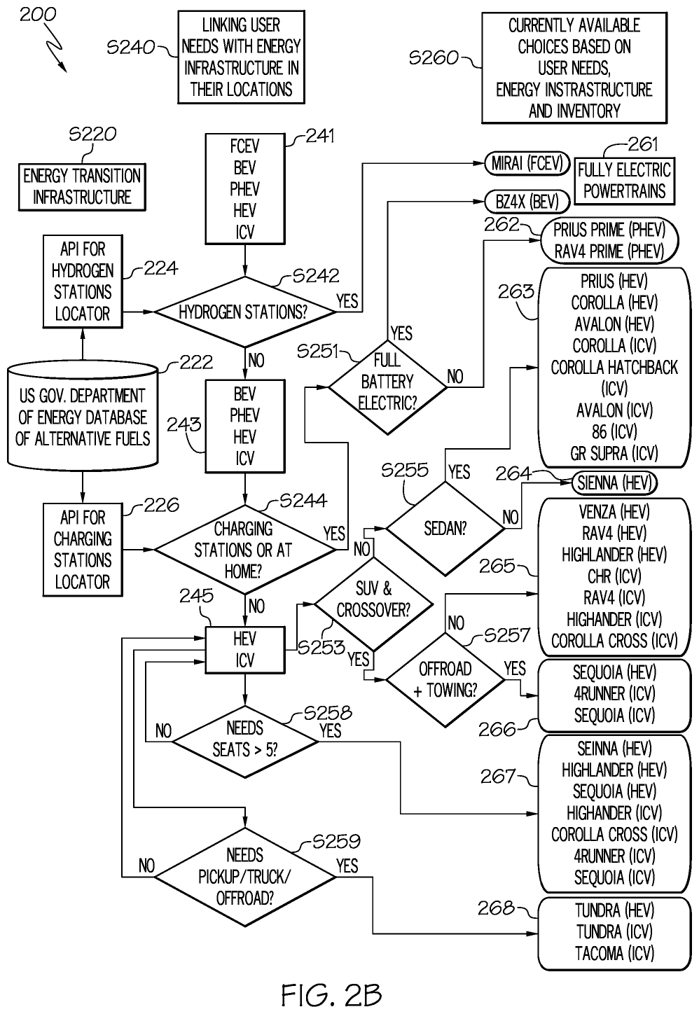

FIG. 2A schematically depicts a flowchart of a method for providing information based on a vehicle powertrain type, according to one or more embodiments shown and described herein.

In step 201, a system (e.g., the system 100) obtains a geographical location related to a user. In embodiments, the system may obtain the geographical location related to the user based on an actual location of the user or where the system is located. For example, the geographical location is obtained based on location information of the user device 160 or location information of the system. In embodiments, the user may input the geographical location related to the user via the user interface input device 121. For example, the user may enter the user's home address, office address, or any address that the user may wish to be associated with. In embodiments, the system may obtain the geographical location related to the user from personal information stored in the memory 129, the database 130 or 150, or the like. In embodiments, the geographical location is associated with a commuting route (e.g., a route from the user's home to the user's office) or a frequently used route (e.g., a route from the user's home or office to a point of interest).

In step 203, the system receives data indicating availability of energy transition infrastructure in an area including the geographical location. In embodiments, the data indicating availability of energy transition infrastructure is stored in the database 150 and the system receives the data via the network 140. Alternatively, the data is stored in the database 130. In embodiments, the processor 127 (alternatively, the server 170) may determine the availability of energy transition infrastructure by determining number of energy transition infrastructure located in the area including the geographical location. Alternatively, or additionally, the processor 127 may determine a distance between the energy transition infrastructure and the geographical location of the user. Alternatively, or additionally, the processor 127 may determine number of energy transition infrastructure located adjacent to the commuting route of the user (e.g., along the commuting route).

In step 205, the system determines a vehicle powertrain type based on the data. The vehicle powertrain type may be determined based on the data indicating the availability of energy transition infrastructure. In embodiments, the processor 127 (alternatively, the server 170) may determine the vehicle powertrain type based on the energy type of the energy transition infrastructure determined to be available to the user. For example, the system may determine the vehicle powertrain type using electricity is recommended for the user when the available energy transition infrastructure is an electronic charging station. When the available energy transition infrastructure is a hydrogen station, the system determines the vehicle powertrain type using hydrogen is recommended for the user. When there is no green energy transition infrastructure (e.g., an electronic charging station, a hydrogen station, or the like) available for the user, the system recommends the vehicle powertrain type using fossil fuel (e.g., diesel, gasoline, or the like).

In step 207, the system determines inventory information of a vehicle having the determined vehicle powertrain type. The system may determine which vehicles having the determined vehicle powertrain type are available for the user for purchase based on the inventory information. The system may also determine when the vehicles having the determined vehicle powertrain type become available for the user.

In step 209, the system provides information related to the vehicle based on the inventory information to the user via a user interface. The system may provide information of only vehicles available to the user for purchase. Alternatively, the system may provide information of all the vehicles having the determined powertrain type and provide availability information of the vehicles. For example, the system provides dates when the vehicles become available when currently there is no inventory. The user interface (e.g., the user interface output device 123, the user device 160, or the like) may display images of the information related to the vehicle. The user interface may display images of the geographical locations of the available energy transition infrastructures, the geographical location of the user, the commuting route of the user, or the like. The user interface may display images of the vehicles (e.g., vehicle body, color, size comparison, or the like) to assist the user selection. In embodiments, when the display is an interactive display, the user may select a vehicle for purchase or for getting details of the vehicle. Also, the user may modify the geographical locations or select different energy transition infrastructure to explore other options.

Referring to FIG. 2B, an exemplary flowchart of a method 200 for providing information based on a vehicle powertrain type is depicted. The method 200 includes three general steps including determining energy transition infrastructure S220, linking user needs with energy infrastructure in their locations S240, and providing currently available choices based on user needs, energy infrastructure, and inventory S260. In embodiments, the method 200 includes more or fewer steps as will be described in details below.

Prior to step S220, the system 100 may obtain a geographical location related to a user. In embodiments, the geographical location related to a user may be provided by the user device 160, obtained from user input or current location of the user, or obtained from data stored in the database 130 or 150. For example, the geographical location related to a user is associated with a user home, a place of work, a commuting route, a point of interest, a frequent location, or the like. For another example, the geographical location related to a user is associated with a user device location, a location of a car dealership, a network access location, or the like. In some embodiments, these geographical locations may have been stored in the user device 160, e.g., according to previous searches, and may be automatically transmitted to the vehicle recommendation module 120 without the user manually input the geographical locations. For example, when the user device 160 is in proximate to or wirelessly connected to the vehicle recommendation module 120, the geographical locations related to the user may be transmitted to the vehicle recommendation module 120. As another example, when the user logs in to the system 100 using the user device 160, the geographical locations related to the user may be transmitted to the vehicle recommendation module 120.

A database 222 (e.g., the database 150) provided by the Department of Energy may provide locations of energy transition infrastructures. By using the external database like the database 150, the vehicle recommendation module 120 may save memories and improve computation efficiencies. The database 222 may be updated to maintain current information of energy transition infrastructures.

When the database 222 is an internal database (e.g., the database 130) of the vehicle recommendation module 120, the database 222 may be updated to maintain current information associated with vehicles and users.

An application programing interface (API) for locating hydrogen stations 224 and an API for locating electric charging stations 226 may determine availability of energy transition infrastructure in an area including the geographical location related to the user. In embodiments, the server 170 may run the APIs for locating energy transition infrastructures 224 and 226. Alternatively, the system 100, specifically the vehicle recommendation module 120, may run the APIs for locating energy transition infrastructure. Similarly, it should be noted that any steps taken in the method 200 may be accomplished by the vehicle recommendation module 120 or the server 170. When the server 170 (e.g., an external server) runs the APIs for locating energy transition infrastructure, the vehicle recommendation module 120 may save memories and processor usage for processing step S200 may be reduced.

The data indicating availability of energy transition infrastructure in the area including the geographical location related to the user is utilized to link user needs with energy infrastructures in user locations (step S240).

At step S240, a vehicle powertrain type based on the data indicating energy transition infrastructure in the area including the geographical location related to the user may be determined.

Electrified vehicle powertrains come in various types. Fuel cell electric vehicles (FCEVs) utilize hydrogen fuel to generate electricity onboard the vehicle. FCEVs emit only water vapor which helps clear the air. There is no CO2 emission.

Battery electric vehicles (BEVs) utilize a large battery to power an electric motor. A small amount of electric energy stored in the battery is sourced onboard from the vehicle through the regenerate braking system and from a solar panel in some cases, but the main energy is sourced externally from grid-based power outlet. Since BEVs have no gasoline or diesel internal combustion engine, there is no tailpipe CO2 emission.

Plugin hybrid electric vehicle (PHEVs) utilize both battery-powered electric motor and gasoline or diesel fueled internal combustion engine. Electric energy stored in the battery is sourced both onboard from the vehicle through regenerative braking system, and externally from grid-based power outlet. PHEVs have smaller batter size than the BEV. PHEVs have tailpipe CO2 emission.

Hybrid Electric Vehicles (HEVs) utilize both battery-powered electric motor and gasoline or diesel fueled internal combustion engine (ICE). However, unlike PHEVs, no external electrical energy source is required. The electric energy stored in the battery is only sourced onboard from the vehicle through regenerative braking system. Thus, HEVs have smaller battery size but consume more gasoline or diesel fuel than PHEVs, and therefore have more tailpipe CO2 emission.

Internal combustion vehicles (ICVs) are powered by a regular ICE. ICVs use fuel which combusts inside a combustion chamber with the help of an oxidizer (typically oxygen from the air). This means that ICVs burn fuel to get power. ICVs commonly use fuels derived from fossil fuels including petroleum, diesel, natural gas, or the like. In addition to fossil fuels, there are also ICVs powered by biofuels (e.g., ethanol and biodiesel) or hydrogen. ICVs are considered to have the most tailpipe CO2 emissions compared to other vehicles powered by alternative energy sources.

Powertrain options 241 including FCEVs, BEVs, PHEVs, HEVs, and ICVs are provided, and the powertrain options 241 are narrowed down to non-hydrogen powertrain options 243 including BEVs, PHEVs, HEVs, and ICVs when it is determined that there is no hydrogen stations in the determined area (i.e., the area including the geographical location related to the user) at step S242. When there are hydrogen stations available in the determined area or there are more hydrogen stations than other energy transition infrastructures, FCEVs are provided as a powertrain option to the user.

When it is determined that there is no electric charging stations in the determined area at step S244, options are narrowed down to powertrain options with ICEs 245, including HEVs and ICVs. In embodiments, at step S242, the system 100 may determine number of electric charging stations and the hydrogen stations in the determined area. When there are more electric charging stations than the hydrogen stations in the determined area, the system 100 may provide the non-hydrogen powertrain options 243. When there are more hydrogen stations than electric charging stations in the determined area, the system 100 may provide the electric powertrain options including BEVs, PHEVs, and HEVs. Similarly, when there are more gas stations than electric charging stations or hydrogen stations, the system 100 may provide the powertrain options with ICEs 245 including HEVs and ICVs.

In embodiments, the vehicle powertrain options are further narrowed down based on user needs associated with factors other than the vehicle powertrain options. The user may provide various preferences and needs via the user device 160 or the system 100. The system 100 may inquire the user via the system 100 or the user device 160 to receive the user input regarding preferences. The system 100 may determine user preferences or needs based on the user profile indicative of personal information from the database 130 or 150 or the user input.

When there are electric charging stations in the determine area or at user's place at step S244, the system 100 may further determine whether the user prefers full battery electric vehicles at step S251. At step S251, the non-hydrogen powertrain options 243 are narrowed down to fully electric powertrain options 261 (e.g., BEVs or PHEVs) depending on the user preferences of full battery electric vehicles. If the user prefers full battery electric vehicles, the system 100 provides BEVs. If the user does not prefer full battery electric vehicles, the system 100 provides PHEV options 262.

At step S253, the system 100 determines whether the user prefers sports utility vehicles (SUVs) or crossovers. When the system 100 determines the user does not prefer SUVs or crossovers at step S253, the system 100 determines whether the user prefers sedans at step S255. When the system 100 determines that the user prefers sedans, the system 100 provides sedan options 263 having powertrain options with ICEs 245 including HEVs and ICVs. When the system 100 determines that the user does not prefer sedans, the system 100 provides non-sedan options 264 having powertrain options with ICEs 245 including HEVs and ICVs.

At step S253, when the system 100 determines that user prefer SUVs and crossovers, the system 100 further determines whether the user prefers off road vehicles capable of towing at step S257. When the system 100 determines that the user does not prefer off road vehicles capable of towing at step S257, the system 100 provides non-off road vehicles capable of towing options 265 having powertrain options with ICEs 245 including HEVs and ICVs. When the system 100 determines that the user prefers off road vehicles capable of towing at step S257, the system 100 provides off road vehicles capable of towing options 266 having powertrain options with ICEs 245 including HEVs and ICVs.

At step S258, the system 100 may determine preferred number of seats based on the number of family of the user. When the user needs seats more than five, the system 100 may provide vehicle options with more than five seats 267.

At step S259, the system 100 may determine whether the user needs pickup trucks, trucks, or off road vehicles. If the system 100 determines that the user needs pickup trucks, trucks, or off road vehicles, the system 100 may provide pickup trucks, trucks or off road vehicle options 268.

At step 260, currently available choices are provided based on user needs, energy infrastructure availabilities, and inventories. In embodiments, the final recommendations 261-268 are provided based on inventory information of each vehicle powertrain type. The system 100 determines the inventory information of each vehicle based on the inventory information received from the database 130 or 150. The inventory information stored in the database 130 or 150 may be updated as needed or periodically to provide current information.

In embodiments, the final recommendations 261-268 include vehicles of a specific automaker. In other embodiments, the final recommendations 261-268 include vehicles of various automakers.

In embodiments, the final recommendations 261-268 are narrowed down based on inventory information. For example, the final recommendations 261-268 only provide vehicle options that are available to the user. Alternatively, the final recommendations 261-268 are provided while including all vehicle options based on the powertrain type along with availability information of each options.

It should be noted that, in embodiments, the system 100 may determine user preferences related to the level of fuel efficiencies or environmental friendliness. In embodiments, the system 100 may determine whether the user prefers full electric vehicles or hybrid based on the user preferences related to the level of fuel efficiencies or environmental friendliness. The system 100 may ask questions to determine user preferences. For example, the system 100 asks questions related to the user preferences to determine which powertrain type the user prefers.

After step S260, the system 100 provides information related to the vehicle based on the inventory information to the user via a user interface (e.g., the user interface output device 123 or the user device 160).

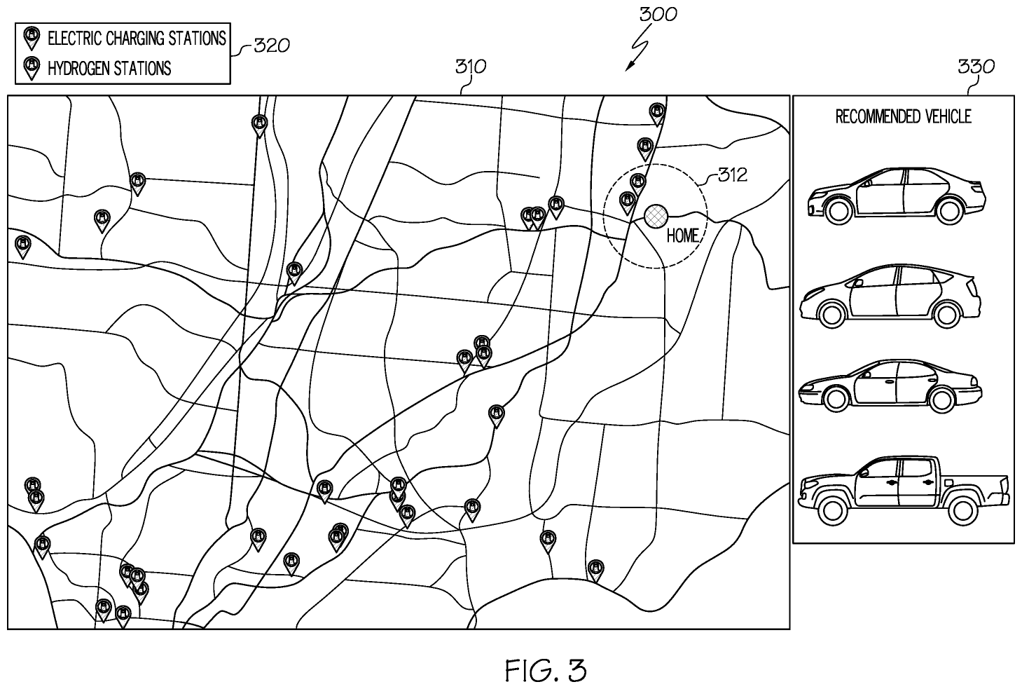

Referring to FIGS. 3-5, the system 100 displays an image of information related to vehicle options (e.g., the final recommendations 261-268) determined by the system 100 on the user interface.

Referring to FIG. 3, an image 300 provides a map 310, map references 320, and recommended vehicles 330. The map 310 may provide locations of electric charging stations and hydrogen stations in a geographical region associated with a home location of a user. For example, there are two electric charging stations in a determined area 312 (e.g., a predetermined area around the home) is a 2-mile radius area around the home location. When there are two electric charging stations and no other energy transition infrastructures in the determined area 312, the system 100 may provide recommended vehicles 330 including electric vehicles (e.g., BEVs, PHEVs).

Also, the recommended vehicles 330 shown in the image 300 include vehicles with 5 seats or less based on the determined user needs or preferences. By providing the image 300 with visual information related to the vehicles and geological locations of energy transition stations, the system 100 may provide a user friendly environment for selecting a vehicle. Visual presentation helps the user selection of a vehicle be more intuitive.

In embodiments, the user interface may be interactive or coupled to an input device (e.g., the user interface input device 121), and the user may zoom in or out the map 310, further select different locations other than the user home location for further considerations. Also, the user may select each vehicle to have access to further details of each vehicle or to purchase the selected vehicle. The user may change the size of the determined area 312.

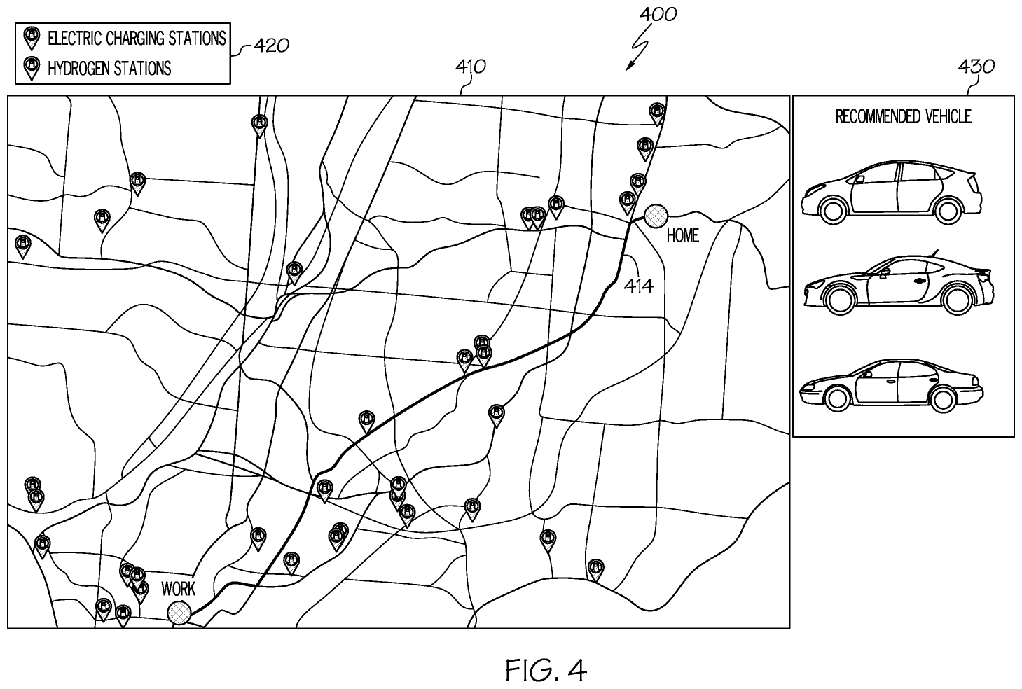

Referring to FIG. 4, an image 400 provides a map 410, map references 420, and recommended vehicles 430. A user may input a home location and a work location, e.g., by inputting the locations or touch the locations on the map 410 that is currently displayed. The map 410 may provide locations of electric charging stations and hydrogen stations in a geographical region. In response to receiving the home location and the work location, the vehicle recommendation module 120 may identify energy transition infrastructure such as electric charging stations and hydrogen stations associated with a commuting route 414 of a user between the home location and the work location. For example, there are two electric charging stations and one hydrogen station adjacent to the commuting route 414 (e.g., along the commuting route 414). Since there are more electric charging stations than the hydrogen stations adjacent to the commuting route 414, the system 100 may provide recommended vehicles 430 including electric vehicles (e.g., BEVs, PHEVs). Also, the recommended vehicles 430 shown in the image 400 include non-off road vehicles based on the determined user needs or preferences. Therefore, the recommended vehicles 430 include SUVs, sedans, or crossovers based on the user needs or preferences.

By providing the image 400 with visual information related to the vehicles and geological locations of energy transition stations, the system 100 may provide a user friendly environment for selecting a vehicle. Visual presentation helps the user selection of a vehicle be more intuitive.

The user interface may be interactive or coupled to an input device (e.g., the user interface input device 121), and the user may zoom in or out the map 410, further select different commuting route or work places or point or interests other than the commuting route 414 for further considerations. Also, the user may provide types of business of the user so that the system 100 may determine the types of vehicles based on the types of business. For example, when the user is in a repair business (e.g., a plumping business, an electrical repair business, or the like), the system 100 may provide vehicles with more cargo space such as pickup trucks or trucks. The system 100 may update the recommended vehicles 430 based on the changes made by the user via the user interface. Also, the user may change the specific route of the commuting route 414 for further considerations.

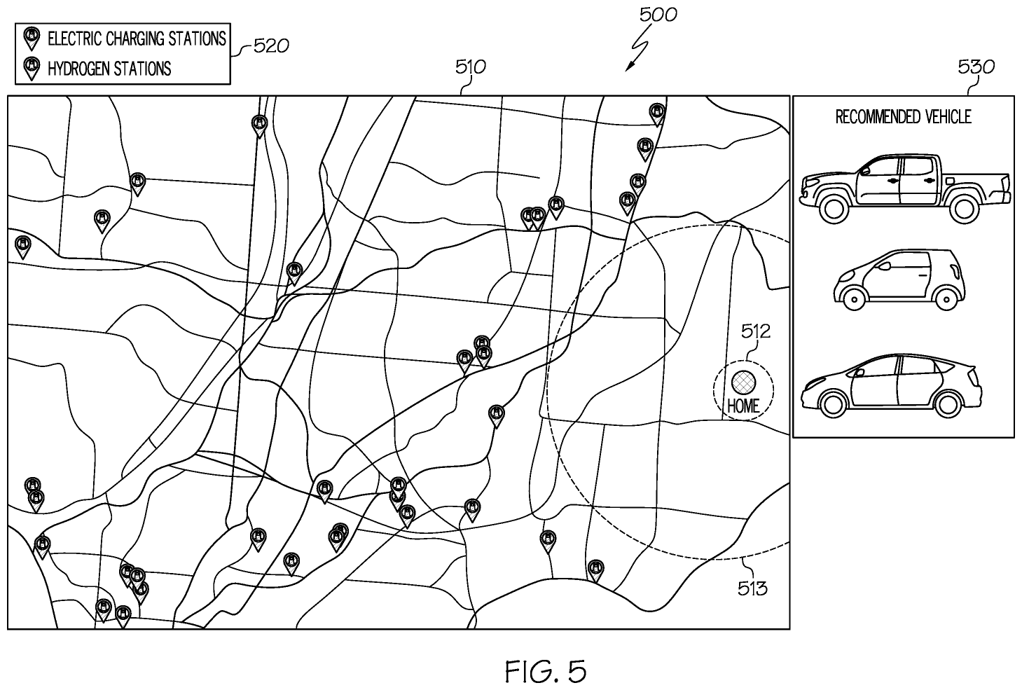

Referring to FIG. 5, an image 500 provides a map 510, map references 520, and recommended vehicles 530. The map 510 may provide locations of electric charging stations and hydrogen stations in a geographical region associated with a home location of a user. A determined area 512 (e.g., a predetermined area around the home), which is a 2-mile radius area around the home location. The image 500 also provides a determined area 513 (e.g., a predetermined area around the home), which is a 10-mile radius area around the home location. For example, there are no hydrogen stations or electric charging stations in the determined area 513 and the determined area 512. Since there are no electric charging stations or the hydrogen stations, the system 100 may provide recommended vehicles 530 having ICEs (e.g., HEVs and ICVs).

Also, the recommended vehicles 530 shown in the image 500 include compact vehicles which have high fuel efficiencies when the system 100 determines that the user prefer high fuel efficiency vehicles based on the determined user needs or preferences. By providing the image 500 with visual information related to the vehicles and geological locations of energy transition stations, the system 100 may provide a user friendly environment for selecting a vehicle. Visual presentation helps the user selection of a vehicle be more intuitive.

The user interface may be interactive or coupled to an input device (e.g., the user interface input device 121), and the user may zoom in or out the map 510, further select different point or interests other than the home location of the user for further considerations. The system 100 may update the recommended vehicles 530 based on the changes made by the user via the user interface.

Although FIGS. 3-5 describes two types of energy transition infrastructures including hydrogen stations and electric charging stations, the system 100 may additionally display gas stations to support user selection by providing more considerations as to the energy transition infrastructure availabilities near user. The system 100 may additionally display other energy transition infrastructures that may become available in the future.

It should now be understood that the embodiments disclosed herein include methods and systems for providing vehicle powertrain options based on various information associated with a user. Embodiments may provide vehicle powertrain options based on an availability of energy transition infrastructure associated with the user's locations, point of interests, commuting routes, or the like. Also, embodiments may further determine needs or preferences of the user to determine vehicle body types, vehicle size, number of seats, or the like.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

1. A method comprising:
obtaining a geographical location related to a user;
receiving data indicating availability of energy transition infrastructure in an area including the geographical location;
determining a vehicle powertrain type based on the data;
determining inventory information of a vehicle having the determined vehicle powertrain type; and
providing information related to the vehicle based on the inventory information to the user via a user interface.

2. The method of claim 1, wherein providing the information includes displaying an image on the user interface indicative of the information related to the vehicle.

3. The method of claim 1, further comprising:
receiving data indicating a customer preference; and
determining inventory information of the vehicle meeting the customer preference.

4. The method of claim 3, wherein the customer preference includes a vehicle body type, a vehicle fuel efficiency, or a vehicle seat number.

5. The method of claim 1, wherein the energy transition infrastructure provides transition of alternative energy.

6. The method of claim 1, wherein the availability of energy transition infrastructure is determined based on geographical vicinity of the energy transition infrastructure and the geographical location.

7. The method of claim 1, wherein the geographical location is based on a geographical location of the user interface.

8. The method of claim 1, wherein the geographical location is based on a commuting route of the user.

9. The method of claim 1, further comprising:
receiving user selection information of the vehicle; and
updating algorithm of providing the information related to the vehicle based on the user selection information.

10. The method of claim 1, further comprising:
receiving updated data indicating the availability of energy transition infrastructure; and
determining the vehicle powertrain type based on the updated data.

11. The method of claim 1, wherein the vehicle powertrain type includes a fuel cell electric vehicle (FCEV), a battery electric vehicle (BEV), a plug-in hybrid electric vehicle (PHEV), a hybrid electric vehicle (HEV), or an internal combustion vehicle (ICV).

12. A system comprising a user interface and a processor that performs a computer-implemented method of:
obtaining a geographical location related to a user;
receiving data indicating availability of energy transition infrastructure in an area including to the geographical location;
determining a vehicle powertrain type based on the data;
determining inventory information of a vehicle having the determined vehicle powertrain type; and
providing information related to the vehicle based on the inventory information to the user via the user interface.

13. The system of claim 12, wherein providing the information includes displaying an image on the user interface indicative of the information related to the vehicle.

14. The system of claim 12, wherein the processor further performs:
receiving data indicating a customer preference; and
determining inventory information of the vehicle meeting the customer preference.

15. The system of claim 14, wherein the customer preference includes a vehicle body type, a vehicle fuel efficiency, and/or a vehicle seat number.

16. The system of claim 12, wherein energy transition infrastructure provides transition of alternative energy.

17. The system of claim 12, wherein the availability of energy transition infrastructure is determined based on geographical vicinity of the energy transition infrastructure and the geographical location.

18. The system of claim 12, wherein the geographical location is based on a geographical location of the user interface.

19. The system of claim 12, wherein the processor further performs:
receiving user selection information of the vehicle; and
updating algorithm of providing the information related to the vehicle based on the user selection information.

20. The system of claim 12, wherein the processor further performs:
receiving updated data indicating the availability of energy transition infrastructure; and
determining the vehicle powertrain type based on the updated data.
